(19) United States
(12) Patent Application Publication
(10) Pub. No.: US 2025/0083981 A1
(43) Pub. Date: Mar. 13, 2025

(54) Fluid Drainage System With Sand-Mimicking Fluid Retentive Wrapping

(71) Applicant: Eljen Corporation, Windsor, CT (US)

(72) Inventor: James M. King, Ellington, CT (US)

(21) Appl. No.: 18/825,539

(22) Filed: Sep. 5, 2024

Related U.S. Application Data
(60) Provisional application No. 63/581,300, filed on Sep. 8, 2023.
(60) Provisional application No. 63/590,148, filed on Oct. 13, 2023.
(60) Provisional application No. 63/594,136, filed on Oct. 30, 2023.

(51) Int. Cl. C02F 3/04; C02F 3/10

(52) U.S. Cl. CPC C02F 3/046; C02F 3/106; C02F 3/107

(57) ABSTRACT

A treatment system for treatment of bio-impacted wastewater includes one or more fluid treatment units with support media and optionally treatment media. A wrapping is included on or around one or more outer areas of the fluid treatment unit in a position for receipt of the wastewater from the treatment unit. The wrapping may include multiple different sheets of fabric or similar and is configured to stimulate growth of biological material from absorbing wastewater from the fluid treatment unit. The wrapping can be configured to mimic key properties of specified sand such as one or more of infiltration rate, bulk density, total pore space, and capillary pore space. The treatment units or wrapping or both may additionally include fabric impregnated with iron, carbon, bacteria, bacterial spores or be formed from carbon-containing materials to enhance treatment of bio-impacted fluid.

### CROSS-REFERENCE TO RELATED APPLICATIONS

This application claims priority to U.S. Provisional Application No. 63/581,300, for Preconfigured Fabric Wrap for Subsoil Fluid Treatment and Treatment Unit, filed Sep. 8, 2023; U.S. Provisional Application No. 63/590,148, for Preconfigured Fabric Wrap for Subsoil Fluid Treatment and Treatment Unit, filed Oct. 13, 2023; and U.S. Provisional Application No. 63/594,136, for Preconfigured Fabric Wrap for Subsoil Fluid Treatment and Treatment Unit, filed Oct. 30, 2023, the entire contents of which are incorporated by reference herein in full.

### BACKGROUND

The present disclosure relates generally to the field of subsoil fluid drainage, absorption and treatment systems, and more particularly to fabric wrappings that are preconfigured to provide certain properties and passive treatment solutions. Fabric may be impregnated with one or more elements that provide wastewater treatment effects, fabric may be designed and configured to mimic preferred treatment fill, and combinations thereof. Multiple layers of fabric with different properties or materials can be used to provide different treatment effects.

In a general sense, some conventional subsoil fluid absorption and treatment systems are comprised of trenches or excavations filled with small rock aggregate and overlaid with a perforated pipe. The pipe may be overlaid with a geotextile fabric and/or more rock aggregate. Soil is placed over the aggregate and perforated pipe to fill the trench to the adjoining ground level. In use, fluid flows through the pipe and out perforations in the pipe. Fluid is held within cavities in the aggregate until it can be absorbed into the soil. Other conventional systems use hollow chambers which may include fabric layers which are installed beneath ground level to hold fluid until the fluid can flow through slits or apertures in the chamber or through a fabric outer layer and can be absorbed into surrounding sand or soil. In some systems, individual fabric-wrapped modules are spaced apart along a length of the excavation and fluid is provided to the interior of the modules. These units and/or systems are referred to as “passive” systems in that they do not require power or other assistance in order to treat wastewater fluid.

In these passive systems, the surrounding sand or soil provides a significant treatment function to the system as a whole. As such, states and municipalities strictly regulate specifications of the sand layer directly surrounding the installed system, including type of sand, location relative to the system, volume and thickness in different directions relative to the system. The primary objective is to provide a sand layer around the installed system that is sufficient to treat the volume of fluid flowing to the system. As such, the specified sand must have certain fluid retentive properties in order to absorb and maintain the fluid for an adequate duration to enable biological growth and deposits referred to in the industry as a biomat layer.

Additionally, systems exist within which an external biodegradable carbon source is added (often wood chips or shavings) for denitrification of the wastewater. Systems also exist within which an external iron source or another source of negatively charged ions is added for converting phosphates present in the wastewater. Other materials, elements or compounds may be added for removing other nutrients from wastewater, essentially designed to treat whichever wastewater pollutant is present and for which removal is desired.

Particularly effective wastewater treatment units/systems are manufactured and sold by Eljen Corporation of Windsor, Connecticut, under the names GSF and Mantis®. By way of further background, within GSF systems, cuspated core sheets of differing thickness are arranged parallel to one another with treatment fabric vertically positioned between adjacent sets of core sheets and over the top of alternating sets of core sheets. A GSF unit has the overall appearance of a rectangular prism with numerous channels on the interior, which may form a serpentine shape. Within Mantis® systems, individual modules formed from internal core sheets wrapped with treatment fabric are spaced apart from one another along a support pipe that passes through the center of each module. In each type of system, modules include a support structure made from a series of cuspated polymeric core sheets with a treatment fabric wrapped around the support structure. In these systems, a fluid conduit, such as a support pipe, delivers wastewater to the interior of the modules.

Drainage systems are placed within an excavated section of property, typically in a substantially flat alignment, and then the excavation is backfilled with soil or sand. As noted above, in such installations, a certain thickness of a specified sand is required to surround the outer side faces and the bottom face of each drainage unit or module in order to satisfy state or municipal regulations, and further to ensure that the wastewater effluent is effectively treated.

Another key consideration in the wastewater treatment process, especially within the Mantis® system, is the surface contact between the outer fabric of the modules and the surrounding sand. Over time, a biomat layer develops on the surface of the fabric (the interface between the fabric and surrounding soil) as well as within the first 10-20 mm of the surrounding sand. The biomat layer is a significant contributor for naturally treating bio-related fluid, such as septic fluid or drainage, in the soil.

One problem exists in certain locales wherein specified sand is not readily available in a close vicinity. Due to weight, volume and containment considerations, shipping sufficient volumes of specified sand to such locales can be exceedingly difficult and costly. Moreover, it can be cumbersome and time consuming to backfill the proper volume of specified sand in the proper configurations to comply with relevant code. In fact, the sand media can be the most significant factor affecting costs of constructing passive subsoil treatment systems.

As such, it would be useful to be able to substitute the specified sand media with a volume of a different material that cures the above-described drawbacks.

### SUMMARY

In one embodiment, a fluid treatment system includes a fluid treatment unit and a wrapping. The fluid treatment unit has one or more channels defining an interior volume for receipt and distribution of wastewater. It also has at least one fabric layer on at least one side of at least one of the one or more channels. The fabric layer is fluid permeable. The wrapping is positioned around at least one outer face of the fluid treatment unit and has a different permeability characteristic from the fabric layer which stimulates growth of biological material from absorbing wastewater from the fluid treatment unit.

In another embodiment, a fluid treatment system has one or more modules and a wrapping. The modules define an interior volume for receipt of wastewater. Each module is enclosed in a fabric layer on two or more outer sides. The wrapping is around at least two sides of the modules and stimulates growth of biological material from absorbing wastewater from the one or more modules.

In yet another embodiment, a wastewater treatment system includes a wastewater treatment unit and multiple layers of fabric. The wastewater treatment unit comprises support media configured to receive a source of wastewater. The multiple layers of fabric are positioned to receive wastewater from the wastewater treatment unit and have different porosities from one another.

In some embodiments, one or more of the multiple layers of fabric comprises carbon impregnated into the fabric material, iron impregnated into the fabric material, one or more bacteria or bacterial spores impregnated into the fabric material, and/or is formed from carbon-containing fibers.

The wastewater treated in any of the embodiments may be impacted with bio-matter and one or more of nitrates and phosphates.

For example, in one embodiment, one or more fabric material layers that have the same absorption and retention properties of the specified sand such that it encourages growth of biomat layer within it and/or at the interface between the substitute fabric and existing fabric layer of a treatment unit.

In some embodiments, the sand-substitute fabric is installable off-site pre-installation to eliminate a step of a typical installation.

In another embodiment, For example, fabric may surround a fluid treatment system with the fabric mimicking preferred fluid absorption and retention properties of specified sand, and which thereby may be used as a substitute for the specified sand. Also disclosed is an embodiment of a fluid treatment system that utilizes the inventive fabric wrapping.

In some embodiments, numerous layers of fabric with specific porosity values can be used to wrap a fluid treatment system.

In some embodiments, layers of fabric with specific porosity values can be laid underneath a fluid treatment system in an excavation.

In yet another embodiment, fabric layers pre-impregnated with carbon may be utilized within the drainage unit, eliminating the need for adding an external carbon source in order to treat nitrogen present in the wastewater.

In yet another embodiment, fabric layers made from materials that inherently include a biodegradable carbon source may be utilized within the drainage unit, which also eliminates the need for adding an external carbon source.

In yet another embodiment, fabric layers pre-impregnated with iron or another negatively charged ion may be utilized within the drainage unit, eliminating the need for adding an external iron source in order to treat phosphates present in the wastewater.

In another embodiment, fabric layers pre-impregnated with calcium are incorporated into the drainage unit for neutralizing pH.

In another embodiment, fabric layers are pre-impregnated with bacterial spores and incorporated into the drainage unit for treating nitrates or other inorganic components. In some embodiments, the spores can be one or more nitrifying bacterium/bacteria and/or any of a group of aerobic bacteria (family Nitrobacteraceae) that use inorganic chemicals as an energy source.

In another embodiment, fabric layers are formed from or a portion thereof includes carbon fiber.

As one of skill in the art would understand from these disclosed embodiments, the fabric may be impregnated with other materials, elements or compounds in order to remove other nutrients from wastewater.

In these embodiments, the wastewater treatment units may be assembled with support sheets and fabric sheets essentially identically to how they are currently assembled yielding treatment units that are inherently capable of treating a wide variety of nutrients present in wastewater.

In this way, the disclosed embodiments provide a fully customizable passive treatment system that reduces or eliminates a need to add external materials useful in treating specific wastewater pollutants.

### BRIEF DESCRIPTION OF THE DRAWINGS

Aspects of the preferred embodiments will be described with reference to the Drawings, where like numerals reflect like elements:

FIG. 1 is a graphical depiction of a wastewater treatment system as known in the art and which must be surrounded with specified sand;

FIG. 2 is a graphical depiction of the same wastewater treatment system with a wrapped layer of material that mimics key properties of specified sand;

FIG. 3 shows a first example of an existing fluid treatment unit with which the inventive wrapping is configured for use;

FIG. 4 shows a second example of an existing fluid treatment unit with which the inventive wrapping may be used;

FIG. 5 depicts a GSF unit installed in a standard subsoil setting as known in the art;

FIG. 6 depicts a GSF unit installed in a subsoil setting with the disclosed wrap layer replacing a layer of specified sand;

FIG. 7 depicts an exemplary sheet of fabric impregnated with a source of carbon;

FIG. 8 depicts an exemplary sheet of fabric impregnated with a source of iron;

FIG. 9 depicts an exemplary sheet of fabric at least a portion of which is formed from carbon fiber;

FIG. 10 depicts an exemplary GSF unit wrapped with one or more impregnated fabric sheets or carbon fiber sheets;

FIG. 11 depicts another exemplary wastewater treatment unit formed with one or more of the disclosed fabric sheets;

FIG. 12 depicts an embodiment of a Mantis-like wastewater treatment unit with modules wrapped in impregnated fabric sheets or carbon fiber sheets;

FIG. 13 shows a side view of another exemplary wastewater treatment unit formed with one or more of the disclosed impregnated fabric sheets or carbon fiber sheets;

FIG. 14 is a partial cross sectional view of the wastewater treatment unit of FIG. 13;

FIG. 15 is a top view of the wastewater treatment unit of FIG. 13 with core sheets of distribution media removed, showing the upright serpentine configuration of the fabric;

FIG. 16 shows another embodiment of a wastewater treatment system installation; and

FIG. 17 is a photograph of an exemplary fluid distribution mat for use with the inventive embodiments.

### DETAILED DESCRIPTION

Among the benefits and improvements disclosed herein, other objects and advantages of the disclosed embodiments will become apparent from the following wherein like numerals represent like parts throughout the figures. Detailed embodiments of a preconfigured fabric wrap and wrap system for subsoil fluid treatment and treatment unit, are disclosed; however, it is to be understood that the disclosed embodiments are merely illustrative of the invention that may be embodied in various forms. In addition, each of the examples given in connection with the various embodiments of the invention are intended to be illustrative, and not restrictive.

Throughout the specification and claims, the following terms take the meanings explicitly associated herein, unless the context clearly dictates otherwise. The phrase “in some embodiments” as used herein does not necessarily refer to the same embodiment(s), although it may. The phrases “in another embodiment” and “in some other embodiments” as used herein do not necessarily refer to a different embodiment, although it may. Thus, as described below, various embodiments may be readily combined without departing from the scope or spirit of the invention.

As used herein, “based on” is not exclusive and permits being based on additional factors not expressly described unless the applicable context clearly dictates otherwise.

In addition, as used herein, the term “or” is equivalent to the term “and/or,” unless the context clearly dictates otherwise. The term “based on” is not exclusive and allows for being based on additional factors not described unless the context clearly dictates otherwise. In addition, throughout the specification, the meaning of “a,” “an,” and “the” include plural references. The meaning of “in” includes “in” and “on.”

Further, the terms “substantial,” “substantially,” “similar,” “similarly,” “analogous,” “analogously,” “approximate,” “approximately,” and any combination thereof mean that differences between compared features or characteristics is less than 25% of the respective values/magnitudes in which the compared features or characteristics are measured and/or defined.

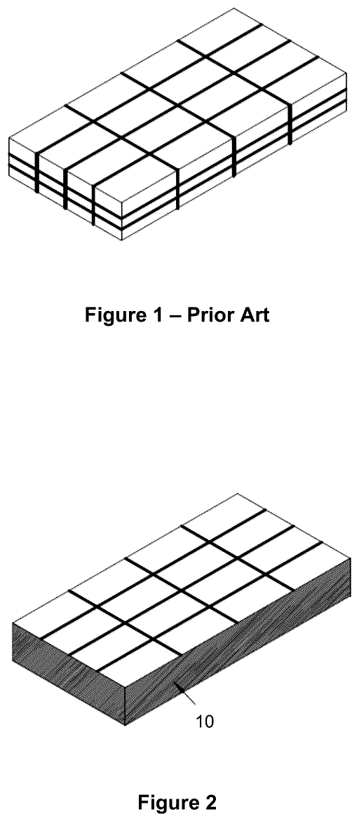

As background to the inventive fluid retentive material and wrap 10 described herein, it is configured to be used in cooperation with elements in fluid treatment systems, such as for example, the GSF and Mantis® systems sold by Eljen Corporation of Windsor, Connecticut, examples of which are shown in FIGS. 1, 3 and 4. However, embodiments of the inventive wrap 10 can be incorporated into any number of other wastewater treatment systems useful for distribution and treatment, wherein a sand layer contributes to treatment efficacy. Installation, use and additional aspects of these types of systems are described in co-owned U.S. Pat. Nos. 8,104,994 and 6,048,131, and U.S. patent application Ser. No. 16/732,392, disclosures of which are incorporated herein by reference for background.

The exemplary treatment systems utilize core sheets as internal support around which fluid-permeable filter fabric is wrapped. The fluid is maintained therein and gradually passes through the fabric layers and eventually into the external environment of sand, soil or other backfill that surrounds each treatment system or module. The systems are all generally self-supporting and self-contained and comprise polymeric core sheets because they are non-absorbent with surrounding layers of treatment fabric, that allow fluid flow into the surrounding environment (backfill) through the fabric layer. Over time, organic deposits develop on the surface of the fabric (the interface between the fabric and surrounding soil), commonly referred to as a biomat layer. The biomat layer is a significant contributor for naturally (passively) treating bio-related fluid, such as septic fluid or drainage, in the soil and which make the products useful for their intended purpose.

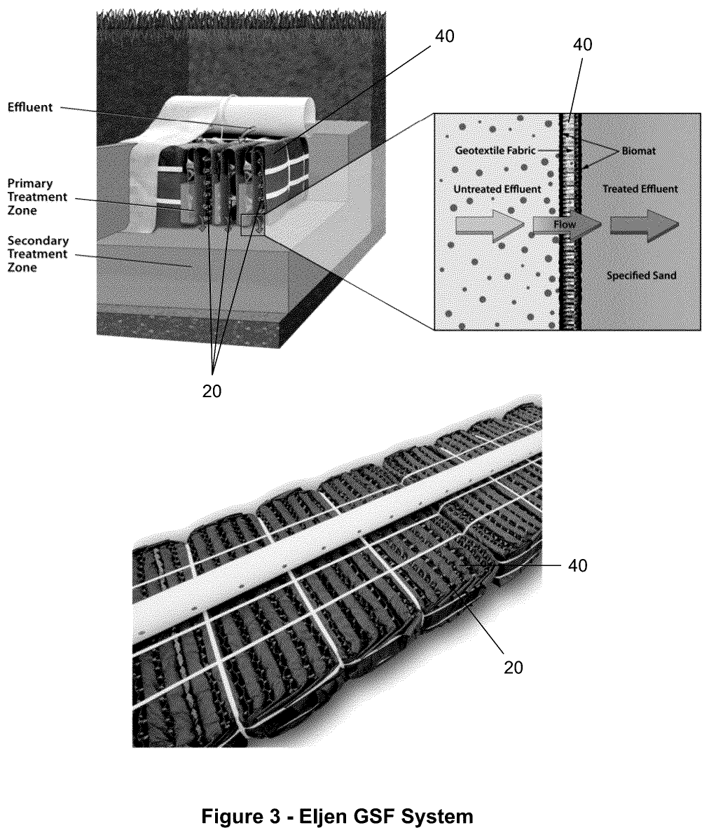

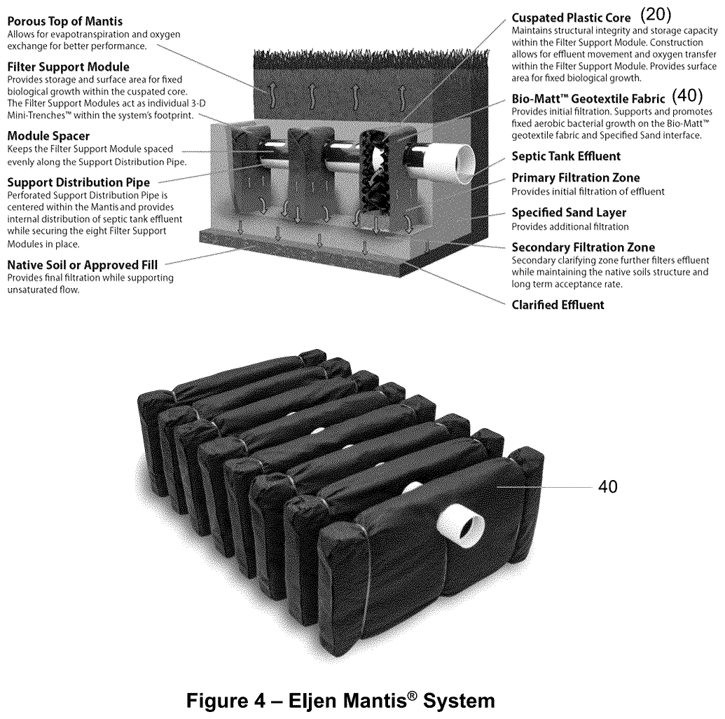

The granular media directly surrounding the fluid treatment unit, such as a GSF or Mantis® unit, must be coarse enough to permit a sufficient flow rate, but fine enough to retain absorbed fluid to provide adequate treatment. Media/sand that is too coarse lowers the wastewater retention time to a point where treatment becomes inadequate. Media/sand that is too fine slows the water movement and increases the chance of clogging the system. The effective size (D10) and uniformity coefficient (Uc) are the principal characteristics of granular media treatment systems. The ideal sand media for such treatment systems is a coarse sand with an effective size between 0.3 mm and 0.5 mm. It is known that the media sand grains should be relatively uniform in size having a low Uc value to promote movement of water and prevent clogging. It is understood in the industry that a preferred sand media should be coarse grade (ES=0.3-0.5), fairly uniform (Uc<4) and washed to minimize fine particles passing a No. 100 sieve. The most widely accepted variety of granular media useful in treating wastewater as described herein is ASTM C33 type sand (Uc=4.6, ES (D₁₀)=0.15-0.35 mm). While the uniformity of ASTM C33 is higher than the ideal range, ASTM C33 sand has been widely adopted throughout the United States as a preferred specified sand for use in passive treatment systems like those shown in FIGS. 3 and 4. Key physical properties of ASTM C33 sand which contribute to efficacy at promoting biomat growth are identified in Table 1 below.

TABLE 1
Performance Data for ASTM C33 Sand Media

| Physical property | Value |
|---|---|
| Infiltration rate (in/hr.) | 12.7 |
| Bulk density (g/cc) | 1.8 |
| Total pore space (%) | 32.3 |
| Capillary pore space (%) | 14.4 |
| Saturation (%) | 14.4 |

The wrap 10 of material depicted in FIG. 2 is installed around a fluid treatment system similar to the above-described GSF system on all surfaces that would typically have specified sand: four side faces and the bottom face (not depicted). The top face is left open for the channels defined within the system to receive wastewater from a conduit, as usual. While not depicted, with a treatment unit like the Mantis® unit, the wrap 10 is wrapped around each spaced apart module so that each surface of filter fabric is surrounded.

The wrap 10 is engineered with physical properties that have been shown to be particularly effective at initiating growth of a biomat layer in all directions, horizontally and vertically, relative to the outer surfaces of the fluid treatment units. These properties generally mimic those of the ASTM C33 specified sand identified in Table 1 above when incorporated into a fluid treatment system, for example used as a wrapping around the side and bottom faces of a GSF unit 100, as depicted in FIG. 6. For example:
Infiltration rate: 10-15 in/hr.; preferably approximately 12.7 in/hr.
Bulk density: 1.3-2.3 g/cc; preferably approximately 1.8 g/cc.
Total pore space: 25-40%; preferably approximately 32.3%.
Capillary pore space: 12-18%; preferably approximately 14.4%.
Saturation: 12-18%; preferably approximately 14.4%.

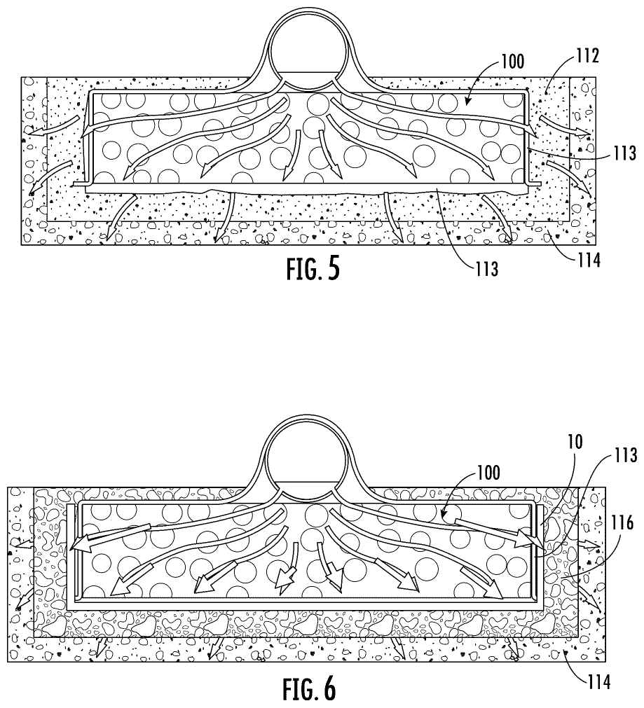

Notably, saturation rate within the context of the inventive embodiments is a measurement of the fluid treatment system as a whole—not a measurement of saturation of the wrap 10 itself. When incorporated into such treatment systems, the wrap 10 is generally saturated, comparable to the upper horizon section 113 of specified sand in known systems (see FIG. 5). The sections surrounding the wrap 10, such as the aggregate 116 and soil backfill 118, experience unsaturated flow, shown in FIG. 6. This is also like the lower horizon layers of the sand 112 and backfill 114 in existing systems, shown in FIG. 5.

The wrap material is comparable, but even preferable to ASTM C33 sand in that it is designed with uniformity in the most preferred range less than 4, which can also be adjusted. Unlike specified sand, ASTM C33 or other, the precise makeup of the wrap 10 can be adjusted for different needs or preferences, including but not limited to adjusting density, pore size and uniformity. The wrap has shown to be at least as effective as ASTM C33 sand layers at stimulating growth of biomat outside the treatment unit and, where applicable, at the filter fabric/wrap material interface when used with common wastewater treatment systems. Like ASTM C33 sand, the engineered wrap 10 allows sufficient breathability to stimulate biomat growth and a wicking factor to wick away excess moisture and maintain unsaturated fluid flow beneath the bottom wrap layer.

While relevant regulations and/or system designs require a relatively thick layer of specified sand on the sides and bottom face of fluid treatment units, like the GSF and Mantis® units, the biological material growth takes place within approximately the first 10 mm of sand. Thus, the wrap 10 is configured to be generally within a range of 10-20 mm thick to emulate this key portion of sand, and has been shown to provide as efficient growth of biomat as the required 6 inches of specified sand.

Additionally, embodiments exist wherein multiple layers of a wrap material are installed. The multiple layers can have the same makeup or different, as may be desired for a given setting and to initiate different treatment results. For example, a wrap layer of a first density, first pore size and first uniformity properties can be wrapped with an additional material layer wherein one or more of the density, pore size and uniformity is different. The resulting wrapped system can absorb wastewater that has been received by the treatment unit at a preferred rate and retain the absorbed wastewater for an appropriate duration to stimulate biomat growth and organic deposits.

In the inventive embodiments, the movement of fluid through different materials (sand or fabric) is calculated using the following equation:

H=C/(R_{V}×S_{E}), wherein
H is capillary movement of water (in mm);
C is an empirical constant of the material (typically, 1-50 mm²);
R_{V} is a void ratio of the material (typically, 0.4-1.0); and
S_{E} is the effective size of the material (0.21 mm).

Here, the empirical constant (C) is a roughness coefficient that is derivable for each material using the Hazen-Williams equation. Void ratio (R_{V}) is a known ratio for each material as well. Effective size (S_{E}) is a value that measures a material's fluid absorption effectiveness, and is determined by multiplying the complete surface area of a given material by the material thickness. The complete surface area includes surface area of fibers in fabrics and grains in sand or aggregate, etc.). Thus, one can adjust the effective size rather easily by adjusting the porousness and/or thickness of a material.

Using the above equation, capillary movement (H) of a known volume of a specified sand can first be calculated. One can thereafter use the calculated capillary movement of the specified sand to determine an appropriate fabric replacement (material, thickness, etc.).

Additionally, in some installations, a second treatment layer can be incorporated into the system. For example, installations exist wherein a carbon-containing layer is positioned beneath a fluid treatment unit (i.e., GSF unit) with wrapping 10 for de-nitrification of effluent passing through the wrapped unit.

The wrap 10 is formed as a fabric, felt, foam, woven material or mesh, which may be woven, twisted, knotted, knit and/or braided. In preferred embodiments, the wrap is formed from a polymeric fiber which may be monofilament, multifilament or a combination thereof. Examples of preferred foam materials include one or more from the non-limiting group consisting of sponge rubbers, silicone, urethanes, and urethane foams. In one embodiment, the wrap 10 is a layer of a Styrofoam mat. Other preferred embodiments of the wrap 10 are formed from polyspun synthetic fibers.

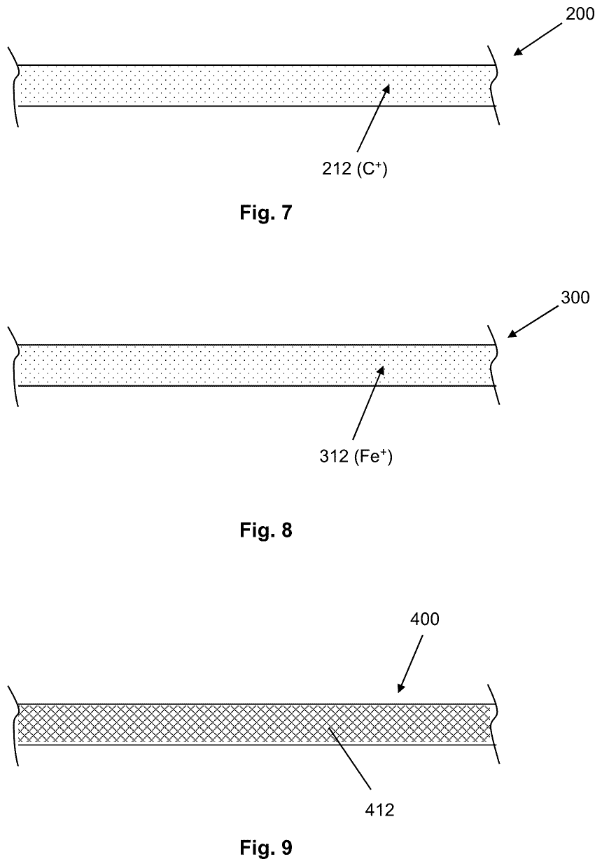

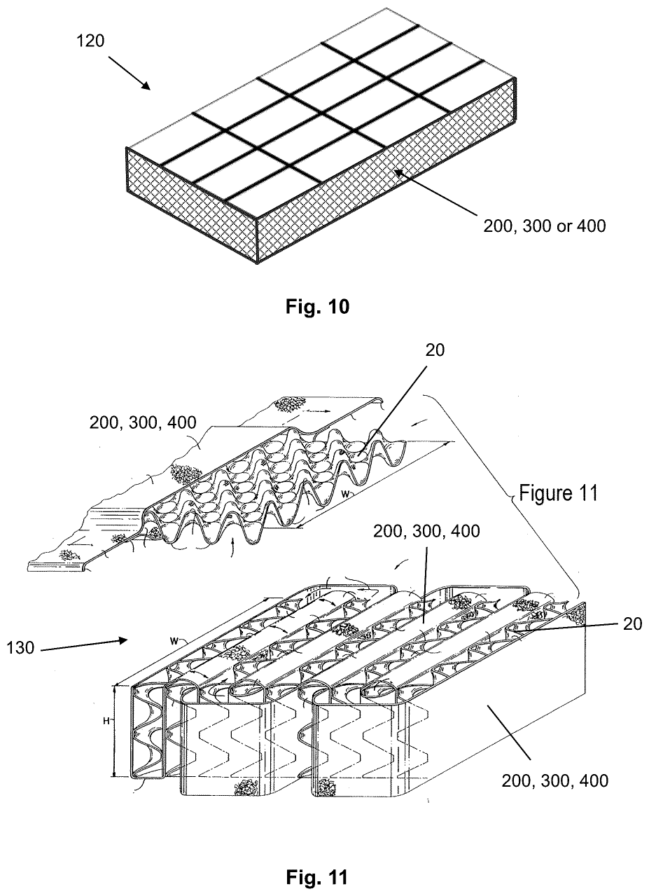

In another embodiment shown first in FIG. 7, a fabric sheet 200 may be impregnated with a carbon source 212 and incorporated into a wastewater treatment system or unit. FIG. 9 shows an alternate embodiment of a sheet 400 that is formed at least partially from a carbon fiber. For example, the sheet 400 may be formed from cocoa, hemp or peat, which provides a natural source of carbon. In practice, one or more carbon-containing fabric sheets like those depicted in FIGS. 7 and 9 can either be wrapped around an existing wastewater treatment unit 120, as shown generally in FIG. 10, yielding a treatment unit capable of passively denitrifying wastewater, in addition to treating bio-related fluid via buildup of biomat layers.

The carbon containing sheets 200 and 400 may also be installed in different locations within a system, such as, for example, laid underneath an installed treatment unit like the depicted GSF or Mantis units.

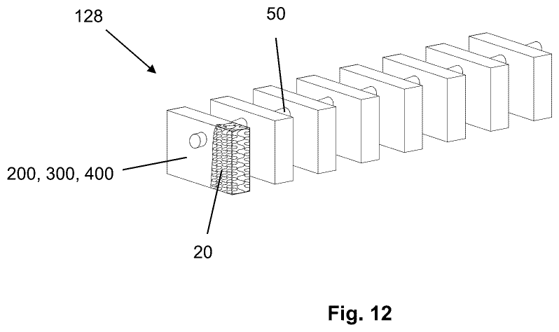

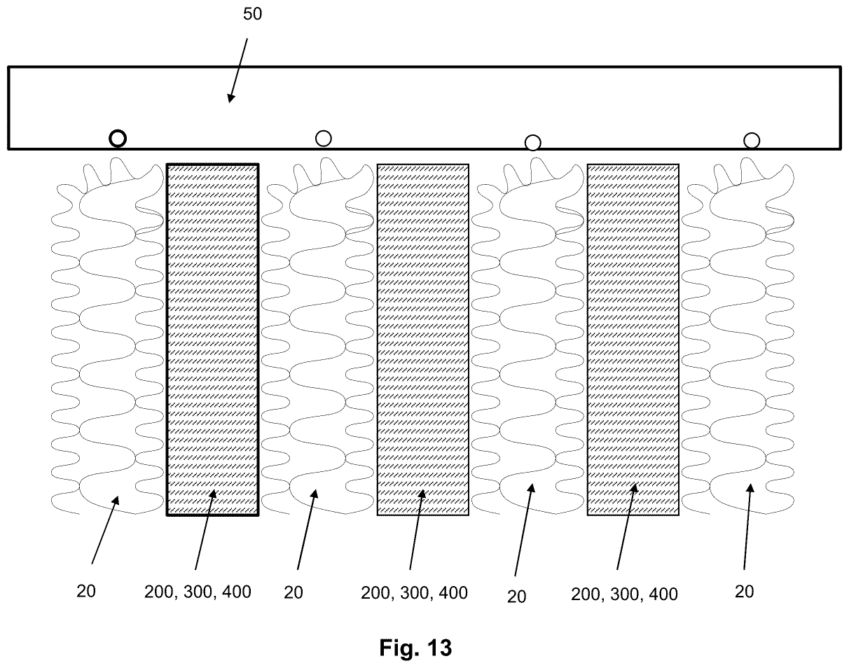

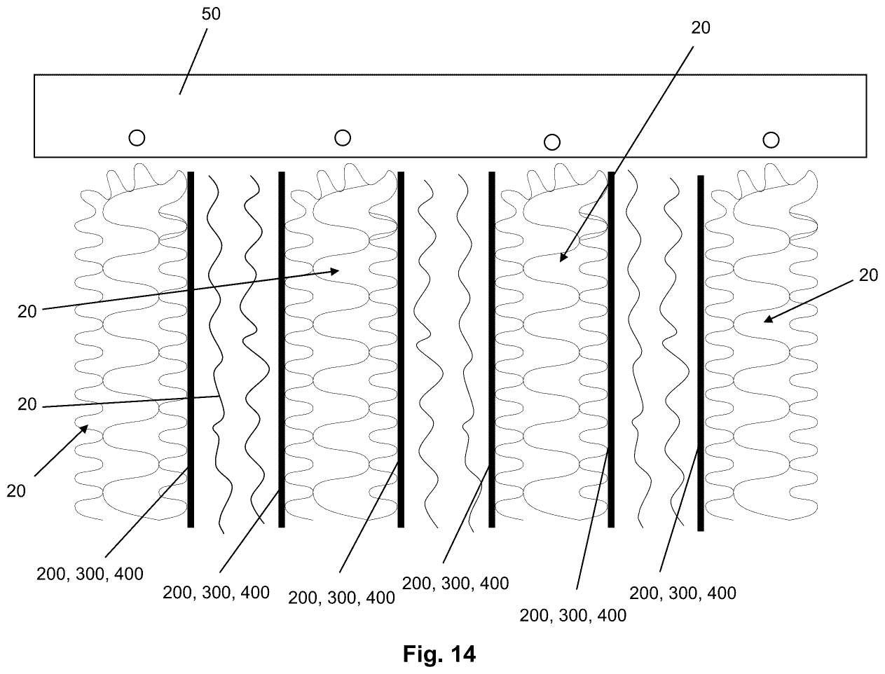

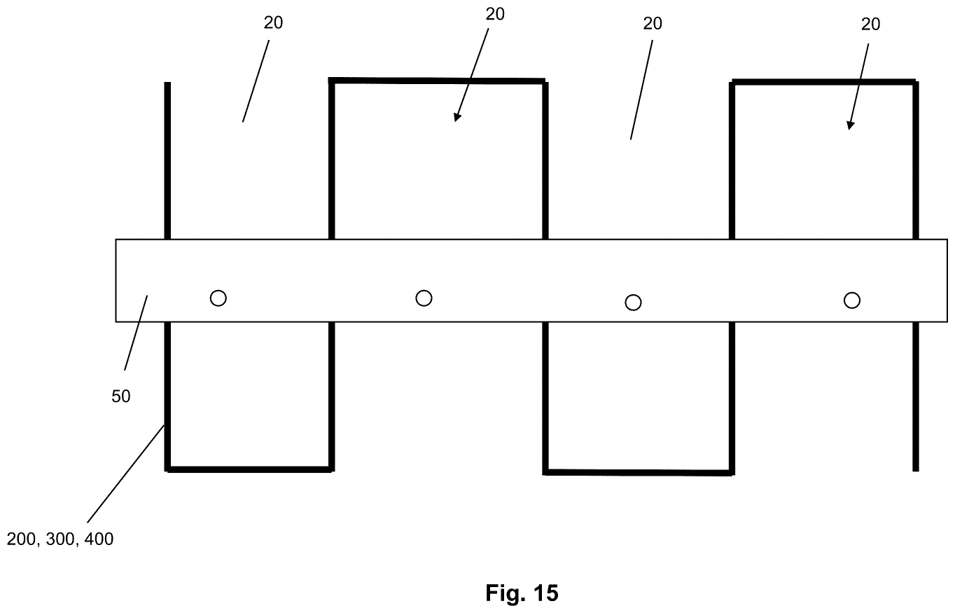

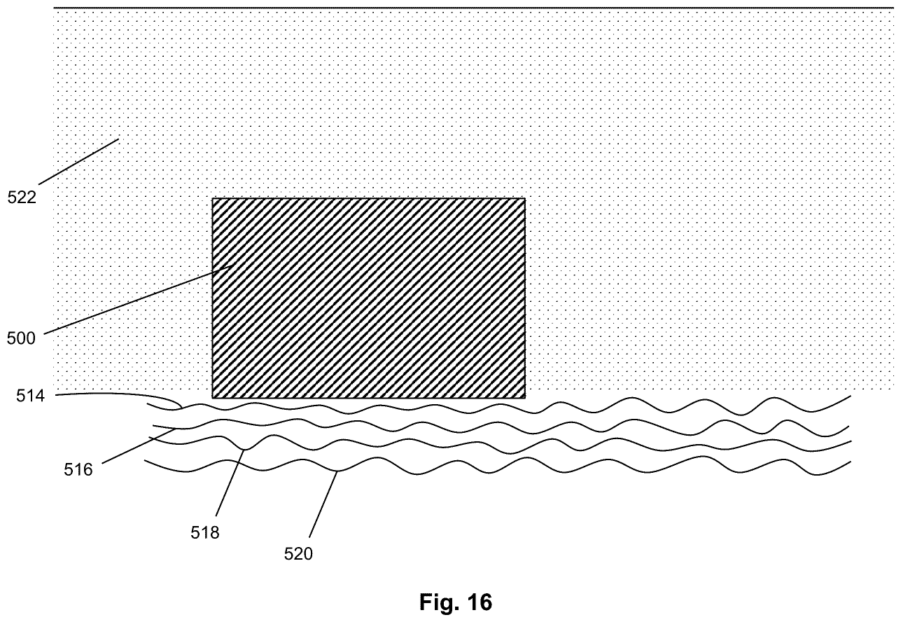

With reference to FIGS. 11-15, in other embodiments, rather than wrapping the inventive fabric around outside surfaces of a treatment unit or laying it elsewhere within a system, the carbon-containing sheets 200 and 400 may also be used in place of traditional filter fabric to assemble wastewater units 128, 130, 140 as they usually are assembled. That is, the carbon-containing sheets 200 and/or 400 may be used in place of traditional non-carbon-containing filter fabric in any number of passive systems, such as a Mantis unit 128 (FIG. 12), In-Drain unit 130 (FIG. 11), GSF unit, and/or any other fabric-containing fluid treatment unit. The respective wastewater treatment units are thereafter installed and used as they traditionally are, by providing a source of wastewater, typically via a pipe 50 overlayed above the top of a unit or extending through separate modules, as in FIG. 12.

In these embodiments, the carbon integrally included in the fabric 200/400 by impregnation or natural fibers facilitates conversion of nitrates present in wastewater to nitrogen gas and other environmentally neutral compounds. Until invention of the disclosed embodiments, a separate source of carbon—often wood chips or sawdust—was always required to be added to a given wastewater treatment system in order to treat nitrates present in wastewater. The disclosed embodiments of wastewater units with carbon-containing fabric have shown efficacy at reducing nitrate concentration in wastewater in a completely passive system without requiring a separate carbon source. The disclosed fabric sheets and separate carbon sources are not necessarily mutually exclusive. In some embodiments, wastewater systems are formulated that utilize a combination of carbon-containing fabric sheets 200 or 400 and an additional source of carbon.

Those skilled in the art will understand that the inventive features described above with respect to carbon-impregnated fabric 200 and carbon fiber fabric 400 can be employed to form fabrics with other inherent properties. For example, FIG. 8 shows an embodiment of a fabric sheet 300 impregnated with an iron source 312 instead of carbon. The iron-containing sheets 300 can be included within wastewater units, as a wrap or incorporated within the assembly of a unit, just as described above with respect to the carbon-containing fabric. The wastewater units with iron-containing sheets 300 have shown efficacy in reducing phosphate content in wastewater, again in a completely passive system without requiring addition of a separate iron source.

In one embodiment, the sheet 300 is impregnated with iron via soaking or pre-treating the fabric in an iron slurry prior to assembly of the drainage units.

In additional embodiments (not depicted), a fabric sheet for use within passive fluid treatment systems is impregnated with bacterial spores that form bacteria useful in treating nitrates and/or other inorganic components commonly found in bio-impacted wastewater. The spores can be one or more nitrifying bacterium/bacteria and/or any of a group of aerobic bacteria (family Nitrobacteraceae) that use inorganic chemicals as an energy source. This fabric impregnated with bacterial spores may be used in combination with other components discussed herein, including carbon, iron and/or calcium sources.

In standard existing wastewater treatment systems with fabric layers, like the GSF and Mantis systems, the innermost section of sand (usually approximately 3-5 mm thickness, but up to approximately 10 mm in heavier flow systems) that interfaces with the outer fabric layer performs an important function, filtering out solids from the biowaste leachate. This allows substantially solid-free bio-impacted fluid to leach further and more evenly into the sand for aerobic treatment, and is preferred. However, the innermost sand section only performs as intended when it is part of a thicker/deeper volume of sand, and thus a significant amount of sand is needed to treat the wastewater. First, it is not physically possible to surround the outer surfaces of a system with only a small volume of sand. Secondly, surrounding a wastewater treatment system with only 10 mm of sand, even if possible, would not yield the same filtration efficacy as the first 10 mm of sand in a larger volume. Thus, it is beneficial to have a system, as provided by the disclosed embodiments, whereby one can mimic the filtration function of the innermost section of sand in such systems without requiring the specified sand, which is costly and challenging to transport and install.

FIG. 16 shows another embodiment of a wastewater treatment system 500 that utilizes a multi-layered fabric or textile composite 512 in place of specified backfill or soil. In this embodiment, successive layers of fabric are aligned in a specific configuration to impart a specific filtration effect. For instance, in FIG. 16, the layers are arranged with decreasing porosity from top to bottom. Of note is that FIG. 16 depicts four fabric layers beneath the wastewater system 500, however, the invention may comprise a wrapping around multiple faces of the system. The invention will be described with reference to FIG. 16, but it is understood to apply to the wrapped configuration as well. In such wrapped systems, typically the successive layers are arranged with decreasing porosity from the innermost layer outward.

In the depicted embodiment, the topmost (or innermost in a wrapped system) layer 514 has a porosity (Apparent Size Opening, i.e., ASO) within an approximate range of 140-200 (measured on ASTM D-4751 scale) and the bottommost (outermost in a wrapped system) layer 520 has a porosity (ASO) within an approximate range of 25-75 (measured on ASTM D-4751 scale) with intermediate layers therebetween. This combination and configuration of layers has shown to closely mimic the fluid filtration characteristics of backfilling with 12″ or more specified sand of ASTM C33 sand (the most common industry standard). The system is installed as usual, by filling the excavation with ordinary backfill 522 which does not need to be or include specified sand. Here, the base beneath the wastewater system and wrapped layers of specified fabric can be formed from other materials that have porosity to allow an aerobic environment, but which are lighter weight and/or less costly than specified sand. These materials create a suitable aerobic environment to initiate and permit treatment of filtered fluid. For example, Styrofoam particles (peanuts or similar) can be used as a base underneath stacked layers of fabric having predetermined porosity properties, as in FIG. 16. In the depiction of FIG. 16, the wastewater system 500 can be any suitable subsoil treatment unit, such as Mantis, GSF or similar.

FIG. 16 shows four layers of fabric, 514, 516, 518, 520, however this is non-limiting. One particularly preferred embodiment of the fabric wrapping or base is a three layered system, wherein an inner fabric layer has an ASO of approximately 170, an intermediate fabric layer has an ASO of approximately 100, and an outermost fabric layer has an ASO of approximately 50. This three-member wrapping or base has shown to mimic filtration characteristics of ASTM C33 sand closely.

Preferably, the innermost fabric layer has an ASO within an approximate range of 140-200, and more preferably within an approximate range of 150-190, and more preferably within an approximate range of 160-180, and even more preferably within an approximate range of 165-175.

In such a system, preferably, the intermediate fabric layer has an ASO within an approximate range of 70-130, and more preferably within an approximate range of 80-120, and more preferably within an approximate range of 90-110, and even more preferably within an approximate range of 95-105.

In the system, preferably, the outermost fabric layer has an ASO within an approximate range of 20-80, and more preferably within an approximate range of 30-70, and more preferably within an approximate range of 40-60, and even more preferably within an approximate range of 45-55.

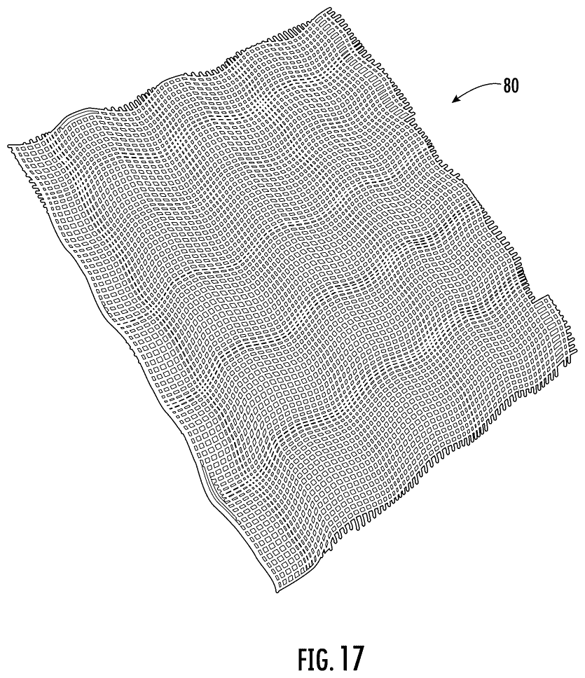

In some embodiments of the layered wrapping or base, one or more fluid distribution mats may be incorporated into the layered system. If present, the fluid distribution mat is typically positioned as the innermost layer closest to the fluid treatment unit to aid an even distribution from the core system to the surrounding sand-mimicking fabric wrapping. However, the particular positioning of the fluid distribution mat is nonlimiting. The distribution mat may be a layer or layers of a non-absorbent porous material that is designed to receive fluid and allow the fluid to spread more evenly across an entire area, in this case, the area of the wrapping or base. The mat is typically formed from a non-absorbent material such that it does not impede fluid flow. In one embodiment, the distribution mat comprises a mesh material, which may have undergone additional surface contour shaping to form undulations or cuspations to provide the sheet with “depth,” which aids fluid distribution efficacy. In another embodiment the mat comprises a polymer mesh sheet with a porous quasi-waffle pattern. In one additional embodiment, such a quasi-waffle polymer sheet includes additional cuspations, similar to the egg-crate contour of the core 20 in the channels (see FIG. 11). FIG. 17 depicts an embodiment of such a mat 80, showing the pores and cuspations. Of course, these are non-limiting examples of a suitable distribution mat or layer.

While preferred embodiments of the foregoing have been set forth for purposes of illustration, the foregoing description should not be deemed a limitation of the invention herein. Accordingly, various modifications, adaptations and alternatives may occur to one skilled in the art without departing from the spirit and the scope of the present invention.

What is claimed is:

1. A fluid treatment system, comprising:
a fluid treatment unit having one or more channels defining an interior volume for receipt and distribution of wastewater, and at least one fabric layer on at least one side of at least one of the one or more channels, the fabric layer being fluid permeable; and
a wrapping around at least one outer face of the fluid treatment unit, wherein
the wrapping has a different permeability characteristic from the fabric layer which stimulates growth of biological material from absorbing wastewater from the fluid treatment unit.

2. The fluid treatment system of claim 1, wherein the wrapping is positioned around multiple surfaces of the fluid treatment unit.

3. The fluid treatment system of claim 1, wherein the wrapping has substantially similar permeability characteristics to ASTM C33 sand as compared to a system without a wrapping which is enveloped in ASTM C33 sand.

4. The fluid treatment system of claim 1, wherein the wrapping exhibits an infiltration rate within an approximate range of 10-15 in/hr.

5. The fluid treatment system of claim 1, wherein the wrapping exhibits a bulk density within an approximate range of 1.3-2.3 g/cc.

6. The fluid treatment system of claim 1, wherein the wrapping exhibits a total pore space within an approximate range of 25-40%.

7. The fluid treatment system of claim 1, wherein the wrapping exhibits a capillary pore space within an approximate range of 12-18.

8. The fluid treatment system of claim 1, wherein the wrapping exhibits:
an infiltration rate within an approximate range of 10-15 in/hr;
a bulk density within an approximate range of 1.3-2.3 g/cc;
a total pore space within an approximate range of 25-40%; and
a capillary pore space within an approximate range of 12-18.

9. The fluid treatment system of claim 1, wherein
the wrapping comprises at least two different layers, including a primary wrapping layer closest to the fluid treatment unit and a secondary layer outside the primary wrapping layer, and
the primary wrapping layer has a higher porosity than the secondary wrapping layer.

10. The fluid treatment system of claim 1, further comprising a treatment sheet of fabric comprising one or more of carbon, iron, bacteria, and bacterial spores, wherein the treatment sheet is positioned outside the fluid treatment unit in a position for receipt of wastewater from the fluid treatment unit.

11. The fluid treatment system of claim 1, wherein the wrap is formed from a polymeric material.

12. A fluid treatment system, comprising:
one or more modules defining an interior volume for receipt of wastewater, each module being enclosed in a fabric layer on two or more outer sides; and
a wrapping around at least two outer sides of the one or more modules, wherein
the wrapping stimulates growth of biological material from absorbing wastewater from the one or more modules.

13. The fluid treatment system of claim 12, wherein the wrapping is a fabric, felt, foam, woven material or mesh.

14. The fluid treatment system of claim 12, wherein one or both of the fabric and wrapping includes one or more of carbon, iron, bacteria, and bacterial spores impregnated into the fabric or the wrapping.

15. The fluid treatment system of claim 12, wherein one or both of the fabric and wrapping is formed from carbon-containing fibers.

16. The filter fabric of claim 15, wherein the carbon-containing fibers are selected from a group consisting of cocoa, hemp and peat.

17. The fluid treatment system of claim 12, wherein the wrapping comprises multiple layers of fabric arranged in order of decreasing porosity with the fabric with the highest porosity closest to the wastewater treatment unit and the fabric with the lowest porosity furthest from the wastewater treatment unit.

18. A wastewater treatment system, comprising:
a wastewater treatment unit comprising support media configured to receive a source of wastewater; and
multiple layers of fabric positioned to receive wastewater from the wastewater treatment unit, wherein
the multiple layers of fabric have different porosities from one another.

19. The wastewater treatment system of claim 18, wherein the layers of fabric are arranged in order of decreasing porosity with the fabric with the highest porosity closest to the wastewater treatment unit and the fabric with the lowest porosity furthest from the wastewater treatment unit.

20. The wastewater treatment system of claim 18, wherein an innermost fabric layer has a porosity within a range of 140-200 (AOS), an outermost fabric layer has a porosity within a range of 25-75 (AOS) and an intermediate fabric layer between the innermost and outermost layers has a porosity within a range of 80-120 (AOS).

21. The wastewater treatment system of claim 18, wherein one or more of the layers of filter fabric are formed from
(i) a filter fabric comprising carbon impregnated into the fabric material,
(ii) a filter fabric comprising iron impregnated into the fabric material,
(iii) a filter fabric formed from carbon-containing fibers, or
(iv) a filter fabric comprising one or more bacteria or bacterial spores impregnated into the fabric material; and
the wastewater is impacted with bio-matter and one or more of nitrates and phosphates.
